(19) United States
(12) Patent Application Publication
(10) Pub. No.: US 2024/0198993 A1
(43) Pub. Date: Jun. 20, 2024

(54) BRAKE SYSTEM AND METHOD FOR BRAKING A VEHICLE HAVING AT LEAST TWO AXLES

(71) Applicant: Robert Bosch GmbH, Stuttgart (DE)

(72) Inventor: Dirk Mahnkopf, Eglosheim (DE)

(21) Appl. No.: 18/556,834

(22) PCT Filed: May 10, 2022
(86) PCT No.: PCT/EP2022/062549

§ 371 Date: Oct. 23, 2023

(30) Foreign Application Priority Data
May 17, 2021 (DE) 102021 204 958.3

(51) Int. Cl. B60T 17/04; B60T 11/26; B60T 13/14; B60T 15/04; B60T 17/22

(52) U.S. Cl. CPC B60T 17/04; B60T 13/142; B60T 17/22; B60T 11/26; B60T 15/045

(57) ABSTRACT

A brake system for a vehicle having at least two axles. The system includes a first and second axle units which can be or are installed on a first and second axle, respectively, of the vehicle. The second axle unit is hydraulically separate from the first axle unit. The first axle unit is a dual-circuit first axle unit. The first and second brake circuits are each configured such that, by operation of a respective motorized brake pressure buildup device, brake fluid can be transferred from a connected brake fluid reservoir into a respective wheel brake cylinder, and, via a respective outlet valve, brake fluid can be discharged from the respective wheel brake cylinder into the connected brake fluid reservoir.

### FIELD

The present invention relates to a brake system for a vehicle having at least two axles. The present invention also relates to a method for braking a vehicle having at least two axles.

### BACKGROUND INFORMATION

Conventional in the related art, such as German Patent Application No. DE 10 2016 208 529 A1, are brake systems for two-axle vehicles, which brake systems have exactly two brake circuits each having two wheel brake cylinders, of which each wheel brake cylinder is hydraulically connected to another wheel brake cylinder of the same brake circuit and, via a master brake cylinder of the relevant brake system, to two further wheel brake cylinders of another brake circuit of the brake system.

### SUMMARY

The present invention provides a brake system for a vehicle having at least two axles, and a method for braking a vehicle having at least two axles.

The present invention provides brake systems for vehicles having at least two axles, which brake systems have a comparatively compact structure and can be produced at relatively low production costs. As becomes clear from the following description, the conventional hydraulic lines between the at least two axles of the vehicle respectively equipped with the brake system are omitted in a brake system according to the present invention. This results in a saving of a relatively large amount of installation space in the relevant vehicle. In addition, installation of the brake system according to the present invention in the relevant vehicle is thus also facilitated.

As also becomes clear from the following description, in a brake system according to an example embodiment of the present invention, the relevant brake pressure in the wheel brake cylinders of the first axle unit thereof can be adjusted fully automatically/fully autonomously, i.e., without a driver brake force being provided by a driver. This can also be referred to as fully automatic/fully autonomous pressure adjustment. Failure of one of the two motorized brake pressure buildup devices of the first axle unit of the brake system according to the present invention can also be compensated for easily by means of (increased or alternative) use of the other of the two motorized brake pressure buildup devices. The brake systems according to the present invention are thus advantageously suitable for use in vehicle types for autonomous driving.

Furthermore, according to an example embodiment of the present invention, by means of the dual-circuit design of the first axle unit, robustness of the first axle unit against leakage occurring at one of the brake circuits thereof is improved. Even if leakage occurs at one of the two brake circuits of the first axle unit during autonomous/automatic driving of the vehicle equipped therewith, the vehicle equipped therewith can at least still be transferred into its safe standstill.

The first axle unit is preferably a “front axle unit.” In the brake systems according to an example embodiment of the present invention, a first brake pressure in the first wheel brake cylinder used as a front-axle wheel brake cylinder and a second brake pressure in the second wheel brake cylinder likewise used as a front-axle wheel brake cylinder can thus be adjusted fully automatically/fully autonomously, i.e., without a driver brake force being provided by a driver of the relevant vehicle. Optionally, however, the first axle unit can also be a “rear axle unit” with the first wheel brake cylinder used as a rear-axle wheel brake cylinder and the second wheel brake cylinder used as a rear-axle wheel brake cylinder. In this case too, the first brake pressure in the first wheel brake cylinder and the second brake pressure in the second wheel brake cylinder can be adjusted fully automatically/fully autonomously.

According to an example embodiment of the present invention, preferably, the first axle unit is designed to be hydraulically separate from the second axle unit in such a way that the first axle unit and the second axle unit are at most connected to one another via at least one signal line and/or bus line. In the embodiment of the brake system described here, the conventional hydraulic lines between the first axle and the second axle of the vehicle equipped with the brake system described here are thus omitted.

In an advantageous embodiment of the brake system of the present invention, the first brake circuit and the second brake circuit of the first axle unit are connected to one another via a brake circuit connection line with a disconnect valve arranged therein, wherein a first mouth of the brake circuit connection line is located at the first brake circuit between the first motorized brake pressure buildup device and the first wheel brake cylinder, and a second mouth of the brake circuit connection line is located at the second brake circuit between the second motorized brake pressure buildup device and the second wheel brake cylinder. The design of the embodiment of the brake system described here with the brake circuit connection line makes it possible to jointly use the first motorized brake pressure buildup device together with the second motorized brake pressure buildup device in order to increase the second brake pressure present in the second wheel brake cylinder, and to jointly use the second motorized brake pressure buildup device together with the first motorized brake pressure buildup device in order to increase the first brake pressure in the first wheel brake cylinder.

As an advantageous development of the present invention, the first brake circuit can also have a first check valve which is arranged between the first mouth of the brake circuit connection line and the first motorized brake pressure buildup device and is oriented in such a way that brake fluid transfer in a direction from the first mouth to the first motorized brake pressure buildup device is prevented by means of the first check valve. The embodiment of the brake system described here can then respond to failure of the first motorized brake pressure buildup device by using the second motorized brake pressure buildup device in a compensating manner, as a result of which the first brake pressure in the first wheel brake cylinder can be built up/increased despite the failure of the first motorized brake pressure buildup device. Alternatively or additionally, the second brake circuit can also have a second check valve which is arranged between the second mouth of the brake circuit connection line and the second motorized brake pressure buildup device and is oriented in such a way that brake fluid transfer in a direction from the second mouth to the second motorized brake pressure buildup device is prevented by means of the second check valve. Active pressure buildup in the second wheel brake cylinder is in this case also possible at a “non-mechanical” fallback level of the first axle unit by building up/increasing the second brake pressure in the second wheel brake cylinder by means of the first motorized brake pressure buildup device. It is expressly pointed out here that, by equipping the brake system with the first check valve and the second check valve, a “non-mechanical” fallback level is brought about, in which, despite failure of one of the two motorized brake pressure buildup devices, autonomous/automatic braking of the relevant vehicle by building up pressure in both wheel brake cylinders of the first axle unit is still possible.

In a further advantageous embodiment of the brake system of the present invention, the first brake circuit has a first isolating valve arranged between the first motorized brake pressure buildup device and the first wheel brake cylinder, and/or the second brake circuit has a second isolating valve arranged between the second motorized brake pressure buildup device and the second wheel brake cylinder. This enables wheel-specific pressure adjustment in both wheel brake cylinders of the first axle unit. This can also be described as wheel-specific, fully automatic/fully autonomous pressure adjustment in the wheel brake cylinders of the first axle unit of the brake system according to the present invention described here. However, it is pointed out that switching of the first isolating valve and/or of the second isolating valve for the wheel-specific, fully automatic/fully autonomous pressure adjustment in the wheel brake cylinders is generally only necessary for modulation, such as ESP or ABS control. Valve switching noises therefore occur relatively rarely during operation of the brake system according to the present invention described here. This is therefore also referred to as a good NVH (noise, vibration, and harshness) characteristic of the brake system according to the present invention disclosed herein.

As a further advantageous development of the present, the first brake circuit can have a third check valve which is arranged parallel to the first isolating valve and is oriented in such a way that brake fluid transfer in a direction from the first wheel brake cylinder to the first motorized brake pressure buildup device is prevented by means of the third check valve, and/or the second brake circuit can have a fourth check valve which is arranged parallel to the second isolating valve and is oriented in such a way that brake fluid transfer in a direction from the second wheel brake cylinder to the second motorized brake pressure buildup device is prevented by means of the fourth check valve. In the embodiment of the brake system described here, in the event that the first/second isolating valve is “stuck” in its closed state, the first/second motorized brake pressure buildup devices can still transfer brake fluid via the third/fourth check valve into the first/second wheel brake cylinder. Additionally equipping the brake system with the third check valve and/or the fourth check valve thus increases a safety standard of the relevant brake system.

Advantageously, according to an example embodiment of the present invention, the first axle unit can also additionally comprise a master brake cylinder to which a brake actuating element of the vehicle can be connected or is connected in such a way that at least one piston of the master brake cylinder delimiting at least one chamber of the master brake cylinder can be displaced by means of actuation of the brake actuating element by a driver of the vehicle, wherein the at least one chamber of the master brake cylinder is hydraulically connected to the brake circuit connection line, to the first brake circuit and/or to the second brake circuit via at least one valveless or valve-equipped connection line. The driver thus has the possibility of using their driver brake force to directly brake into the wheel brake cylinders of the first axle unit in order to still bring about a buildup of brake pressure in the wheel brake cylinders of the first axle unit in this way. The embodiment of the brake system described here thus also has a mechanical fallback level.

Preferably, according to an example embodiment of the present invention, the second axle unit is also a dual-circuit second axle unit which comprises a third brake circuit having a third motorized brake pressure buildup device, a third wheel brake cylinder assigned to the first wheel of the second axle, and a third outlet valve, and a fourth brake circuit having a fourth motorized brake pressure buildup device, a fourth wheel brake cylinder assigned to the other wheel of the second axle, and a fourth outlet valve, wherein the third brake circuit and the fourth brake circuit are each designed in such a way that, by means of operation of the motorized brake pressure buildup device thereof, brake fluid can be transferred from the or another connected brake fluid reservoir into the wheel brake cylinder thereof, and, via the outlet valve thereof, brake fluid can be discharged from the wheel brake cylinder thereof into the connected brake fluid reservoir. The above-described advantages of the first axle unit can thus also be realized correspondingly for the second axle unit.

The advantages described above are also ensured when a corresponding method for braking a vehicle having at least two axles is performed. It is expressly pointed out that the method for braking a vehicle having at least two axles can be developed according to the example embodiments of the brake system of the present invention explained above.

### BRIEF DESCRIPTION OF THE DRAWINGS

Further features and advantages of the present invention will be explained in the following with reference to the figures.

FIGS. 1 to 10 are schematic partial representations of example embodiments of the brake system of the present invention.

FIG. 11 shows a flowchart for explaining an example embodiment of the method of the present invention for braking a vehicle having at least two axles.

### DETAILED DESCRIPTION OF EXAMPLE EMBODIMENTS

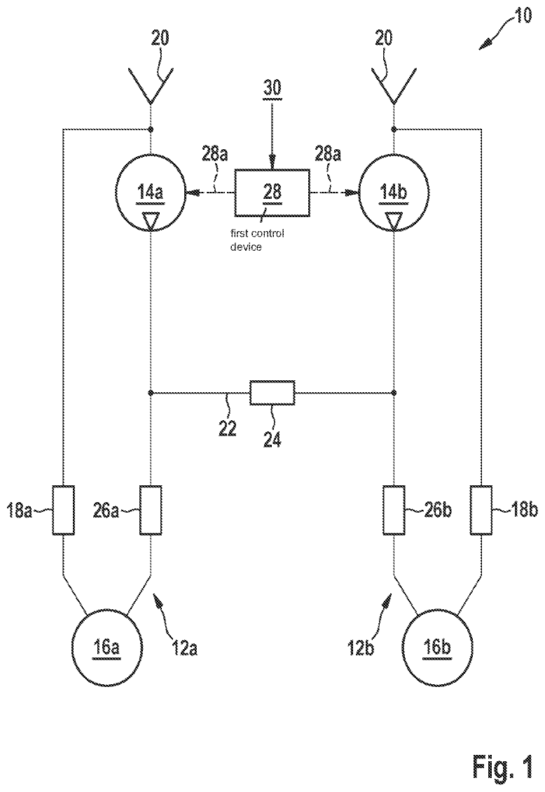

FIG. 1 shows a schematic partial representation of a first embodiment of the brake system.

The brake system shown schematically in FIG. 1 can be installed/is installed in a vehicle/motor vehicle having at least two axles, wherein usability of the brake system is not restricted to any special vehicle type/motor vehicle type of the two-axle vehicle/motor vehicle.

The brake system of FIG. 1 has a first axle unit 10 which can be installed/is installed on a first axle of the vehicle. In addition, the brake system also has at least one second axle unit (not shown in FIG. 1) which can be installed/is installed on a second axle of the vehicle and is designed to be hydraulically separate from the first axle unit 10. The second axle unit is designed in such a way that a first wheel of the second axle and another wheel of the second axle can be braked/are braked by means of operation of the second axle unit. If the vehicle equipped with the brake system has more than two axles, the brake system can also comprise at least one third axle unit which is designed to be hydraulically separate from the first axle unit 10 and the second axle unit, it also being possible for the at least one third axle unit to be able to be installed/to be installed on at least one third axle of the vehicle and to be designed in such a way that a first wheel of at least the one third axle and another wheel of at least the one third axle can be braked/are braked by means of operation of the at least one third axle unit.

Designing the first axle unit 10 to be hydraulically separate from the second axle unit is understood to mean that no hydraulic line runs between the first axle unit 10 and the second axle unit. Since the first axle unit 10 is designed to be hydraulically separate from the second axle unit, the conventionally required hydraulic lines between the axles equipped with the wheel brake cylinders are omitted in the brake system of FIG. 1. The brake system thus has a very compact and space-saving structure. In particular, a modular structure of the brake system can be realized at comparatively low production costs. The first axle unit 10 and the second axle unit can also be installed as two separate units on the two-axle vehicle equipped therewith. This also facilitates installation of the brake system described here. Correspondingly, designing the at least one third axle unit to be hydraulically separate from the first axle unit 10 and the second axle unit is also understood to mean that no hydraulic line runs between the at least one third axle unit and the first axle unit 10 or the second axle unit.

Preferably, the first axle unit 10 can be installed/is installed as a “front axle unit” on the front axle of the vehicle, while the second axle unit and, where applicable, the at least one third axle unit can be installed/is installed as a “rear axle unit” on the rear axle of the vehicle and/or as a “central axle unit” on at least one axle of the vehicle located between the front axle and the rear axle. In this case, the first axle unit serves to brake the front wheels of the vehicle, while the rear wheels and/or the center wheels of the vehicle can be braked by means of the second axle unit and, where applicable, the at least one third axle unit. Alternatively, however, it is also possible for the first axle unit 10 to be able to be installed/to be installed as a “rear axle unit” on the rear axle of the vehicle or as a “central axle unit” on the at least one axle of the vehicle located between the front axle and the rear axle.

The first axle unit 10 is a dual-circuit first axle unit, which comprises a first brake circuit 12a and a second brake circuit 12b. The first brake circuit 12a has a first motorized brake pressure buildup device 14a, a first wheel brake cylinder 16a and a first outlet valve 18a. Correspondingly, the second brake circuit 12b is also formed with a second motorized brake pressure buildup device 14b, a second wheel brake cylinder 16b and a second outlet valve 18b. The first outlet valve 18a and/or the second outlet valve 18b is preferably a switch valve. In addition, a normally closed valve is preferred for the first outlet valve 18a and/or the second outlet valve 18b.

The first motorized brake pressure buildup device 14a is designed in such a way that a first brake pressure in the first wheel brake cylinder 16a can be increased by means of operation of the first motorized brake pressure buildup device 14a such that a first wheel of the first axle assigned to the first wheel brake cylinder 16a can be braked/is braked. A second brake pressure in the second wheel brake cylinder 16b can also be increased by means of operation of the second motorized brake pressure buildup device 14b such that another wheel of the first axle assigned to the second wheel brake cylinder 16b can be braked/is braked. The first brake circuit 12a and the second brake circuit 12b are thus each designed in such a way that, by means of operation of the motorized brake pressure buildup device 14a or 14b thereof, brake fluid can be transferred/is transferred from a connected brake fluid reservoir 20 into the wheel brake cylinder 16a or 16b thereof and, via the outlet valve 18a or 18b thereof, brake fluid can be discharged/is discharged from the wheel brake cylinder 16a or 16b thereof into the connected brake fluid reservoir 20.

The dual-circuit design of the first axle unit 10 ensures better robustness of the first axle unit 10 against leakage occurring at one of the brake circuits 12a or 12b thereof. Even if leakage occurs at one of the two brake circuits 12a or 12b of the first axle unit 10 during autonomous/automatic driving of the vehicle equipped therewith, the components of the other brake circuit 12a or 12b can still perform their function such that the vehicle can at least still be transferred into its safe standstill.

In the brake system of FIG. 1, a high redundancy of the first axle unit 10 is therefore achieved by few modifications. In addition, many “identical” parts, i.e., parts of the same type, can be used for the first axle unit 10. The first axle unit 10 can therefore be produced comparatively cost-effectively and by using brake system components already conventionally used.

The first motorized brake pressure buildup device 14a and/or the second motorized brake pressure buildup device 14b can, for example, each be at least one pump. The first axle unit 10 can thus be designed to be relatively cost-effective. However, the design of the motorized brake pressure buildup devices 14a and 14b of the first axle unit 10 shown in FIG. 1 as a pump in each case is to be interpreted only as an example.

Each of the motorized brake pressure buildup devices 14a and 14b of the first axle unit 10 can also be used to bring about a fully automatic/fully autonomous brake pressure buildup in the wheel brake cylinder 16a or 16b of the same brake circuit 12a or 12b. Both the first brake pressure in the first wheel brake cylinder 16a and the second brake pressure in the second wheel brake cylinder 16b can thus be built up/increased fully automatically/fully autonomously, i.e., without a driver brake force being provided by a driver of the relevant vehicle. The first axle unit 10 is thus particularly well suited for autonomously/automatically braking the vehicle equipped therewith, in particular during fully autonomous/fully automatic driving of the relevant vehicle.

As an advantageous development, the first brake circuit 12a and the second brake circuit 12b in the first axle unit 10 described here are connected to one another via a brake circuit connection line 22 with a disconnect valve 24 arranged therein. The disconnect valve 24 can optionally be a switch valve or a continuously adjustable valve suitable for differential pressure adjustment. The disconnect valve 24 is preferably a normally closed disconnect valve.

The design of the brake circuit connection line 22 at least makes it possible to jointly use the second motorized brake pressure buildup device 14b together with the first motorized brake pressure buildup device 14a to increase the first brake pressure in the first wheel brake cylinder 16a, and to jointly use the first motorized brake pressure buildup device 14a together with the second motorized brake pressure buildup device 14b to increase the second brake pressure in the second wheel brake cylinder 16b. Nevertheless, the effects of leakage at one of the two brake circuits 12a or 12b of the first axle unit 10 can be limited by closing the disconnect valve 24. Preferably, a first mouth of the brake circuit connection line 22 is located at the first brake circuit 12a between the first motorized brake pressure buildup device 14a and the first wheel brake cylinder 16a, while a second mouth of the brake circuit connection line 22 is located at the second brake circuit 12b between the second motorized brake pressure buildup device 14b and the second wheel brake cylinder 16b.

As a further advantageous development, the first brake circuit 12a also has a first isolating valve 26a arranged between the first motorized brake pressure buildup device 14a, or the first mouth of the brake circuit connection line 22 at the first brake circuit 12a, and the first wheel brake cylinder 16a. Likewise, the second brake circuit 12b also has a second isolating valve 26b arranged between the second motorized brake pressure buildup device 14b, or the second mouth of the brake circuit connection line 22 at the second brake circuit 12b, and the second wheel brake cylinder 16b. The first wheel brake cylinder 16a is thus disconnectable/disconnected from the first motorized brake pressure buildup device 14a by closing the first isolating valve 26a, while brake fluid is still transferable/transferred into the second wheel brake cylinder 16b by means of the first brake pressure buildup device 14a. Where applicable, the second wheel brake cylinder 16b is also disconnectable/disconnected from the second motorized brake pressure buildup device 14b by closing the second isolating valve 26b, while brake fluid can be transferred/is transferred into the first wheel brake cylinder 16a by means of operation of the second motorized brake pressure buildup device 14b. By equipping the first axle unit 10 with the first isolating valve 26a and/or the second isolating valve 26b, wheel-specific pressure adjustment in both wheel brake cylinders 14a and 14b of the first axle unit 10 of the brake system can thus be performed. For example, ESP or ABS control is possible as the wheel-specific, fully automatic/fully autonomous pressure adjustment in the wheel brake cylinders 14a and 14b. The at least one isolating valve 26a and 26b of the first axle unit 10 can optionally be a switch valve or a continuously adjustable valve suitable for differential pressure adjustment. Preferably, the at least one isolating valve 26a and 26b is in each case a normally open valve.

Optionally, the first axle unit 10 can have a first control device 28 which is designed and/or programmed to control at least the first motorized brake pressure buildup device 14a, the second motorized brake pressure buildup device 14b, the first outlet valve 18a, and the second outlet valve 18b, and, where applicable, also the at least one further valve 24, 26a and 26b of the first axle unit 10 by means of at least one control signal 28a, taking into account at least one brake specification signal 30, in such a way that, at least temporarily, brake fluid can be transferred/is transferred into the first wheel brake cylinder 16a and/or the second wheel brake cylinder 16b by means of operation of the first motorized brake pressure buildup device 14a and, at least temporarily, brake fluid can be transferred/is transferred into the first wheel brake cylinder 16a and/or the second wheel brake cylinder 16b by means of operation of the second motorized brake pressure buildup device 14b. The at least one brake specification signal 30 can be output to the first control device 28 by at least one brake actuating element sensor of the vehicle, an automatic speed control system of the vehicle, a second control device of the second axle unit, and/or a further stabilization device of the brake system. The at least one brake actuating element sensor can, for example, be a rod travel sensor and/or a differential travel sensor. The automatic speed control system can, for example, be an automatic system for driverless driving of the vehicle, an adaptive cruise control, and/or an emergency brake system. The further stabilization device of the vehicle can in particular be understood to mean an ESP or an ABS control unit. The first axle unit 10 can thus cooperate with a multitude of different electronic components in order to adjust the pressure in the wheel brake cylinders 14a and 14b.

As an advantageous development, the first control device 28 can also be designed to receive and evaluate sensor signals of an upstream pressure sensor (not shown) of the first axle unit 10, at least one wheel pressure sensor (not shown) of the first axle unit 10, at least one wheel speed sensor (not shown), a yaw rate sensor and/or an acceleration sensor of at least one of the wheels of the first axle of the vehicle. Likewise, the control device 28 can also be designed to co-control at least one motor (not shown in FIG. 1) of the vehicle used as a generator for recuperative braking of the vehicle or to communicate advantageous information for the recuperative braking of the vehicle to the motor.

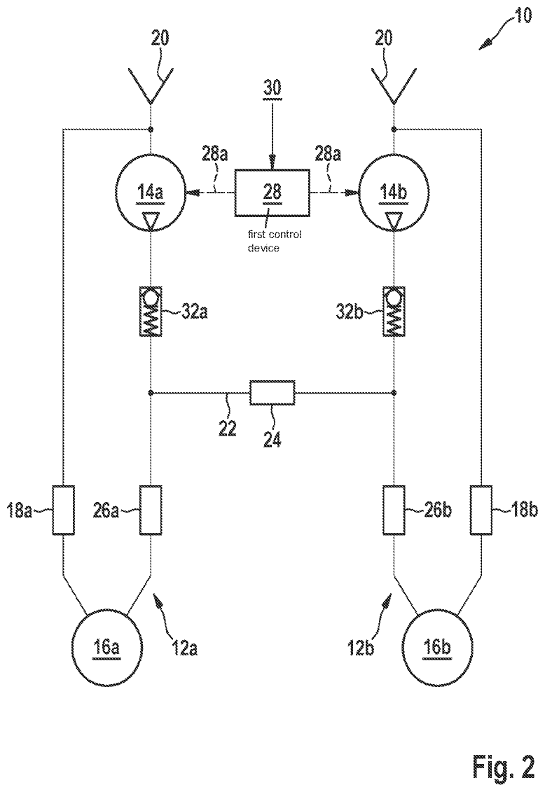

FIG. 2 shows a schematic partial representation of a second embodiment of the brake system.

As a development in comparison with the embodiment of FIG. 1, the brake system shown schematically in FIG. 2/its first axle unit 10 also has a first check valve 32a arranged between the first mouth of the brake circuit connection line 22 at the first brake circuit 12a and the first motorized brake pressure buildup device 14a. The first check valve 32a is oriented in such a way that brake fluid transfer in a direction from the first mouth of the brake circuit connection line 22 at the first brake circuit 12a to the first motorized brake pressure buildup device 14a is prevented by means of the first check valve 32a. Equipping the first brake circuit 12a with the first check valve 32a makes it possible to build up brake pressure in the first wheel brake cylinder 16a exclusively by means of operation of the second motorized brake pressure buildup device 14b, in particular in the event of failure of the first motorized brake pressure buildup device 14a, because the first check valve 32a prevents brake fluid transfer via the first motorized brake pressure buildup device 14a into the connected brake fluid reservoir 20. Preferably, the second brake circuit also has a second check valve 32b which is arranged between the second mouth of the brake circuit connection line 22 at the second brake circuit 12b and the second motorized brake pressure buildup device 14b and is oriented in such a way that brake fluid transfer in a direction from the second mouth of the brake circuit connection line 22 at the second brake circuit 12b to the second motorized brake pressure buildup device 14b is prevented by means of the second check valve 32b.

When the first axle unit 10 is equipped with the two check valves 32a and 32b, failure of one of the two motorized brake pressure buildup devices 14a and 14b of the first axle unit 10 can thus be responded to by using the other of the two motorized brake pressure buildup devices 14a and 14b of the first axle unit 10 in a compensating manner. Active pressure buildup in the first wheel brake cylinder 16a and/or in the second wheel brake cylinder 16b is thus also possible at the “non-mechanical” fallback level of the first axle unit 10 realized by means of the two check valves 32a and 32b. In particular, autonomous braking of the relevant vehicle by means of the first axle unit thereof is also possible at the “non-mechanical” fallback level.

With respect to further features and properties of the brake system of FIG. 2 and their advantages, reference is made to the above-explained embodiment of FIG. 1.

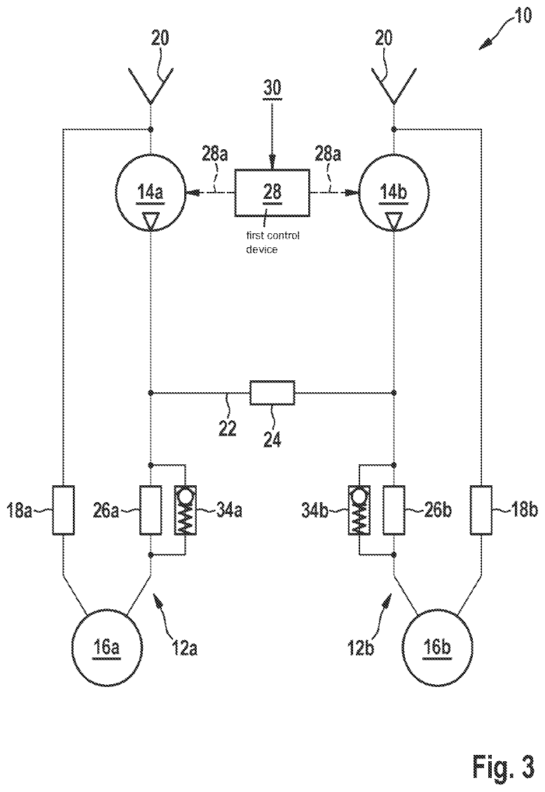

FIG. 3 shows a schematic partial representation of a third embodiment of the brake system.

As an addition to the embodiment of FIG. 1, the first brake circuit 12a in the first axle unit 10 of the brake system of FIG. 3 also has a third check valve 34a which is arranged parallel to the first isolating valve 26a and is oriented in such a way that brake fluid transfer in a direction from the first wheel brake cylinder 16a to the first motorized brake pressure buildup device 14a is prevented by means of the third check valve 34a. In the event that the first isolating valve 26a is “stuck” in its closed state, the first motorized brake pressure buildup device 14a can transfer brake fluid via the third check valve 34a into the first wheel brake cylinder 16a. Optionally, the second brake circuit 12b can also have a fourth check valve 34b which is arranged parallel to the second isolating valve 26b and is oriented in such a way that brake fluid transfer in a direction from the second wheel brake cylinder 16b to the second motorized brake pressure buildup device 14b is prevented by means of the fourth check valve 34b. In this case, the second motorized brake pressure buildup devices 14b can still transfer brake fluid into the second wheel brake cylinder 16b via the fourth check valve 34b even in the event that the second isolating valve 26b is “stuck” in its closed state. Additionally equipping the brake system/the first axle unit 10 thereof with the third check valve 34a and/or the fourth check valve 34b thus increases a safety standard of the relevant brake system.

As an advantageous development, the first axle unit 10 of FIG. 3 can also have the first check valve 32a and/or the second check valve 32b, the positions and orientations of which are described above, as a result of which the “non-mechanical” fallback level is ensured. With respect to further features and properties of the brake system of FIG. 3 and their advantages, reference is therefore made to the above-explained embodiments of FIGS. 1 and 2.

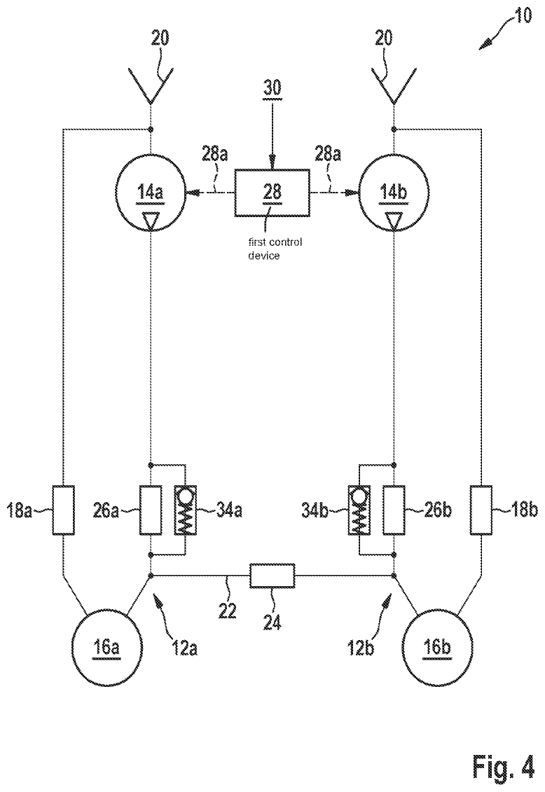

FIG. 4 shows a schematic partial representation of a fourth embodiment of the brake system.

The first axle unit 10 shown schematically in FIG. 4 differs from the embodiment of FIG. 3 only in that the first mouth of the brake circuit connection line 22 is located at the first brake circuit 12a between the first isolating valve 26a and the first wheel brake cylinder 16a, while the second mouth of the brake circuit connection line 22 is located at the second brake circuit 12b between the second isolating valve 26b and the second wheel brake cylinder 16b. This ensures the advantageous “non-mechanical” fallback level even though equipping the first brake circuit 12a with the first check valve 32a and the second brake circuit 12b with the second check valve 32b is dispensed with. Especially in the embodiment of FIG. 4, the first isolating valve 26a and/or the second isolating valve 26b are each preferably a normally open valve.

With respect to further features and properties of the brake system of FIG. 4 and their advantages, reference is therefore made to the above-explained embodiments of FIGS. 1 to 3.

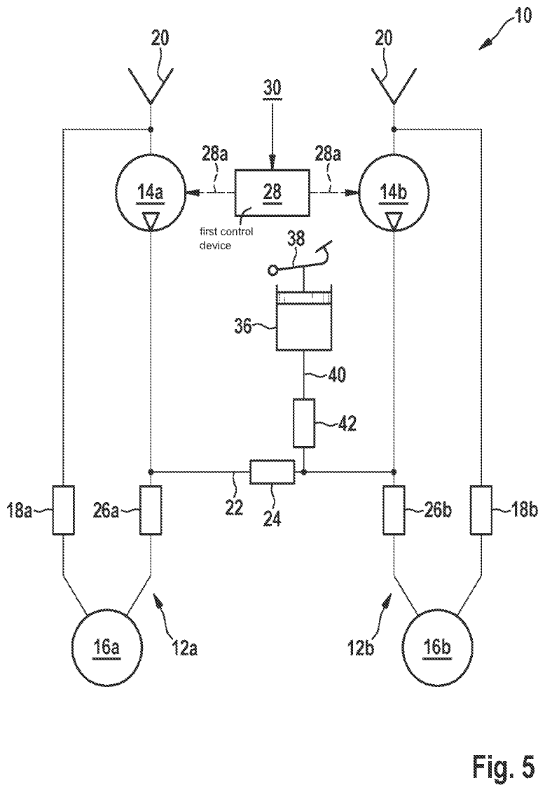

FIG. 5 shows a schematic partial representation of a fifth embodiment of the brake system.

In the brake system of FIG. 5, the first axle unit 10 comprises a master brake cylinder 36 to which a brake actuating element 38 of the vehicle can be connected/is connected in such a way that at least one piston of the master brake cylinder 36 delimiting at least one chamber of the master brake cylinder 36 can be displaced/is displaced by means of actuation of the brake actuating element 38 by a driver of the vehicle. In addition, the at least one chamber of the master brake cylinder 36 is hydraulically connected to the brake circuit connection line 22, to the first brake circuit 12a and/or to the second brake circuit 12b via at least one valveless or valve-equipped connection line 40.

In the brake system of FIG. 5, a mechanical fallback level is thus formed in which, in particular in the event of failure of the first motorized brake pressure buildup device 14a and/or the second motorized brake pressure buildup device 14b, the driver can still bring about a brake pressure buildup in the wheel brake cylinders 16a and 16b by means of their driver brake force applied to the brake actuating element 38. Thus, even in the event of failure of the vehicle on-board power supply of their vehicle, the driver can still reliably transfer the vehicle into a standstill by means of the increase in brake pressure brought about in the wheel brake cylinders 16a and 16b. The brake actuating element 38 can be a brake pedal 38, for example.

At least one master brake cylinder disconnect valve 42 can be inserted in the at least one connection line 40. During operation of the first motorized brake pressure buildup device 14a and/or of the second motorized brake pressure buildup device 14b, the master brake cylinder 36 can thus be/get disconnected from the first motorized brake pressure buildup device 14a and/or from the second motorized brake pressure buildup device 14b by closing the at least one master brake cylinder disconnect valve 42, in such a way that the driver brake force applied to the brake actuating element 38 has no influence on the brake pressures respectively present in the wheel brake cylinders 16a and 16b. The at least one master brake cylinder disconnect valve 42 can optionally be a switch valve or a continuously adjustable valve suitable for differential pressure adjustment. The at least one master brake cylinder disconnect valve 42 is preferably a normally open valve. Although not shown in FIG. 5, a simulator can also be connected to the master brake cylinder 36 so that the driver actuating the brake actuating element 38 when the at least one master brake cylinder disconnect valve 42 is closed has a standard brake actuating feel/pedal feel.

Only by way of example, in the first axle unit 10 of FIG. 5, the single connection line 40 equipped with the single master brake cylinder disconnect valve 42 leads to a portion of the brake circuit connection line 22 between the disconnect valve 24 and the second mouth of the brake circuit connection line 22 at the second brake circuit 12b. In addition, the first check valve 32a and the second check valve 32b can also be inserted in the above-described positions and orientations in the first axle unit 10 so that, during the mechanical fallback mode, the first motorized brake pressure buildup device 14a and/or the second motorized brake pressure buildup device 14b does not impair, as a “volume sink,” the increase in brake pressure in the wheel brake cylinders 16a and 16b brought about by means of the driver brake force.

With respect to further features and properties of the brake system of FIG. 5 and their advantages, reference is made to the above-explained embodiments of FIGS. 1 to 4.

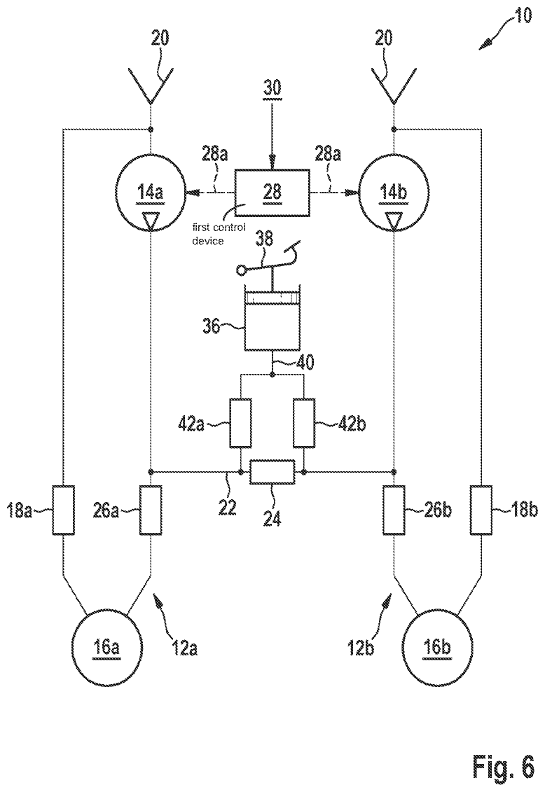

FIG. 6 shows a schematic partial representation of a sixth embodiment of the brake system.

In the brake system shown schematically in FIG. 6, the first axle unit 10 thereof differs from the embodiment described above only in the single connection line 40 branching into two partial lines in such a way that a first partial line of the branched connection line 40 leads to the portion of the brake circuit connection line 22 between the disconnect valve 24 and the first mouth of the brake circuit connection line 22 at the first brake circuit 12a and a second partial line of the branched connection line 40 leads to a portion of the brake circuit connection line 22 between the disconnect valve 24 and the second mouth of the brake circuit connection line 22 at the second brake circuit. In addition, a first master brake cylinder disconnect valve 42a is arranged in the first partial line of the branched connection line 40, while a second master brake cylinder disconnect valve 42b is located in the second partial line of the branched connection line 40.

As an advantageous development, the first check valve 32a and the second check valve 32b can be inserted in their above-described positions and orientations in the first axle unit 10 so that, during the mechanical fallback mode, the first motorized brake pressure buildup device 14a and/or the second motorized brake pressure buildup device 14b does not impair, as a “volume sink,” the increase in brake pressure in the wheel brake cylinders 16a and 16b brought about by means of the driver brake force.

With respect to further features and properties of the brake system of FIG. 6 and their advantages, reference is made to the above-explained embodiments of FIGS. 1 to 5.

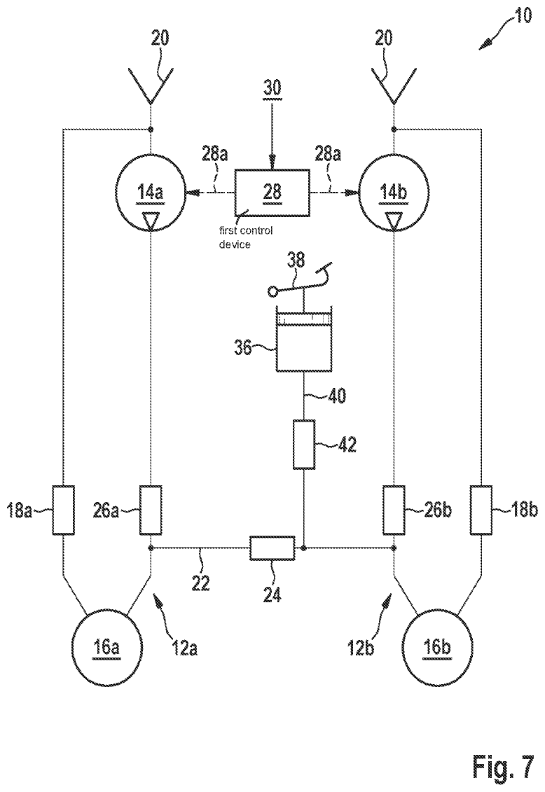

FIG. 7 shows a schematic partial representation of a seventh embodiment of the brake system.

The brake system of FIG. 7 shown schematically by means of its first axle unit 10 differs from the embodiment of FIG. 5 only in that the first mouth of the brake circuit connection line 22 is located at the first brake circuit 12a between the first isolating valve 26a and the first wheel brake cylinder 16a, while the second mouth of the brake circuit connection line 22 is located at the second brake circuit 12b between the second isolating valve 26b and the second wheel brake cylinder 16b. The closed first isolating valve 26a and/or the closed second isolating valve 26b can thus disconnect the first motorized brake pressure buildup device 14a and/or the second motorized brake pressure buildup device 14b from the master brake cylinder 36 in such a way that, during the mechanical fallback mode, neither the first motorized brake pressure buildup device 14a nor the second motorized brake pressure buildup device 14b reduces, as a “volume sink,” the increase in brake pressure in the wheel brake cylinders 16a and 16b brought about by means of the driver brake force. Especially in the embodiment of FIG. 7, the first isolating valve 26a and/or the second isolating valve 26b are each preferably a normally open valve.

With respect to further features and properties of the brake system of FIG. 7 and their advantages, reference is made to the above-explained embodiments of FIGS. 1 to 5.

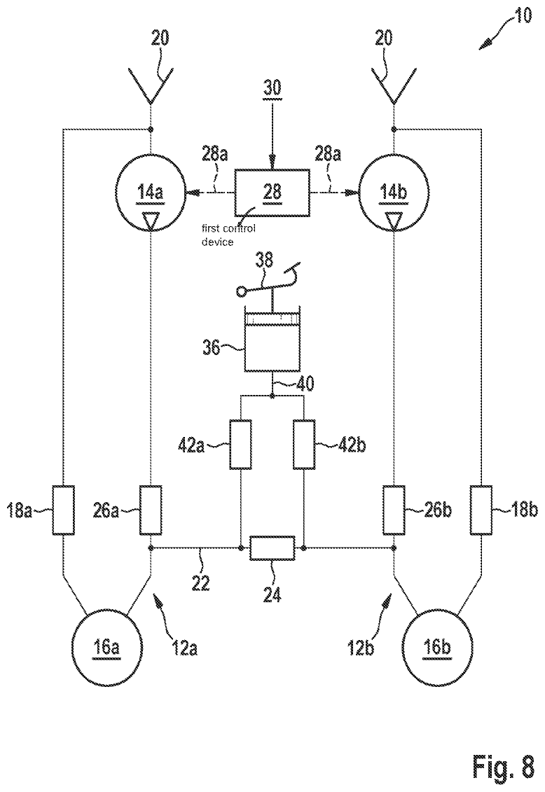

FIG. 8 shows a schematic partial representation of an eighth embodiment of the brake system.

In contrast to the embodiment of FIG. 6, in the brake system of FIG. 8, the first mouth of the brake circuit connection line 22 is formed at the first brake circuit 12a between the first isolating valve 26a and the first wheel brake cylinder 16a, and the second mouth of the brake circuit connection line 22 is formed at the second brake circuit 12b between the second isolating valve 26b and the second wheel brake cylinder 16b. The closed first isolating valve 26a and/or the closed second isolating valve 26b can therefore disconnect the first motorized brake pressure buildup device 14a and/or the second motorized brake pressure buildup device 14b from the master brake cylinder 36 in such a way that, during the mechanical fallback mode, neither the first motorized brake pressure buildup device 14a nor the second motorized brake pressure buildup device 14b reduces, as a “volume sink,” the increase in brake pressure in the wheel brake cylinders 16a and 16b brought about by means of the driver brake force. In the embodiment of FIG. 8 too, the first isolating valve 26a and/or the second isolating valve 26b are each preferably a normally open valve.

With respect to further features and properties of the brake system of FIG. 8 and their advantages, reference is made to the above-explained embodiments of FIGS. 1 to 6.

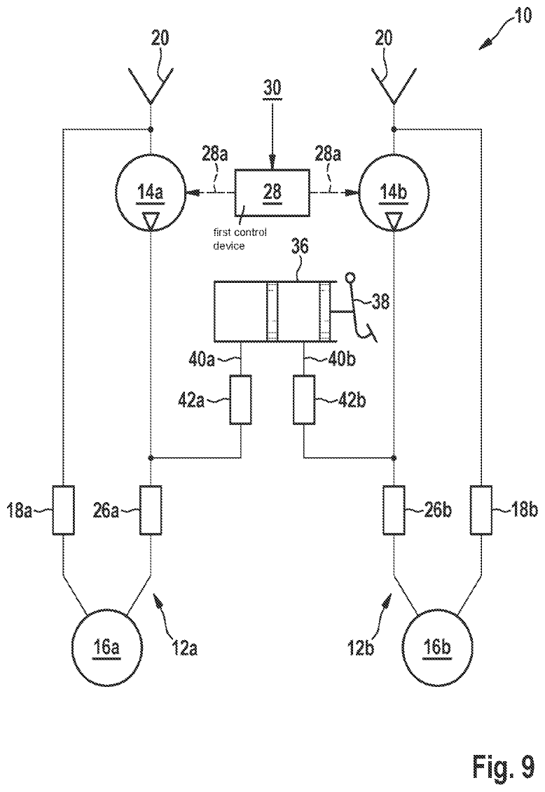

FIG. 9 shows a schematic partial representation of a ninth embodiment of the brake system.

In the brake system of FIG. 9, the master brake cylinder 36 is a tandem master brake cylinder 36, wherein a first chamber of the master brake cylinder 36 is connected to a portion of the first brake circuit 12a between the first motorized brake pressure buildup device 14a and the first isolating valve 26a by means of a first connection line 40a with the first master brake cylinder disconnect valve 42a, and a second chamber of the master brake cylinder 36 is connected to a portion of the second brake circuit 12b between the second motorized brake pressure buildup device 14b and the second isolating valve 26b by means of a second connection line 40b with the second master brake cylinder disconnect valve 42b.

In the brake system of FIG. 9 too, the first check valve 32a and the second check valve 32b can be inserted in their above-described positions and orientations in the first axle unit 10 so that, during the mechanical fallback mode, the first motorized brake pressure buildup device 14a and/or the second motorized brake pressure buildup device 14b does not impair, as a “volume sink,” the increase in brake pressure in the wheel brake cylinders 16a and 16b brought about by means of the driver brake force.

With respect to further features and properties of the brake system of FIG. 9 and their advantages, reference is made to the above-explained embodiments of FIGS. 1 to 8.

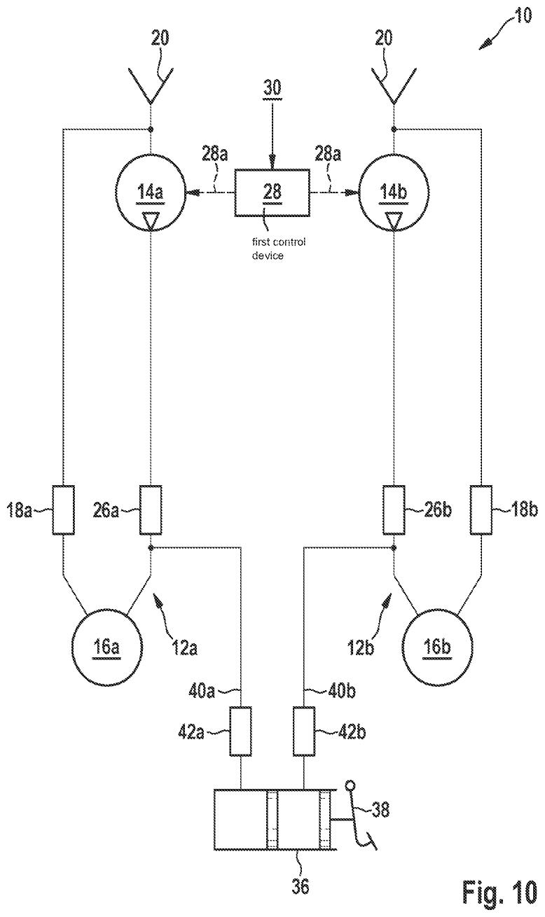

FIG. 10 shows a schematic partial representation of a tenth embodiment of the brake system.

In contrast to the embodiment of FIG. 9, in the brake system of FIG. 10, the first chamber of the master brake cylinder 36 is connected to a portion of the first brake circuit 12a between the first isolating valve 26a and the first wheel brake cylinder 16a by means of the first connection line 40a with the first master brake cylinder disconnect valve 42a, while the second chamber of the master brake cylinder 36 is connected to a portion of the second brake circuit 12b between the second isolating valve 26b and the second wheel brake cylinder 16b by means of the second connection line 40b with the second master brake cylinder disconnect valve 42b. The closed first isolating valve 26a and/or the closed second isolating valve 26b can therefore also ensure in the brake system of FIG. 10 that, during the mechanical fallback mode, neither the first motorized brake pressure buildup device 14a nor the second motorized brake pressure buildup device 14b impairs, as a “volume sink,” the increase in brake pressure in the wheel brake cylinders 16a and 16b brought about by means of the driver brake force. Especially in the embodiment of FIG. 10, the first isolating valve 26a and/or the second isolating valve 26b are each preferably a normally open valve.

With respect to further features and properties of the brake system of FIG. 10 and their advantages, reference is made to the above-explained embodiments of FIGS. 1 to 9.

In all brake systems described above, the first axle unit 10 is preferably designed to be hydraulically separate from the second axle unit in such a way that the first axle unit 10 and the second axle unit are at most connected to one another via at least one signal line and/or bus line. The connection which is in this case realized by means of the at least one signal line and/or bus line between the first axle unit 10 and the second axle unit is space-saving but nevertheless enables good cooperation between the first axle unit 10 and the second axle unit. The at least one signal line and/or bus line can, for example, be a vehicle bus of the vehicle. For example, the first control device 28 of the first axle unit 10 and a second control device of the second axle unit can be connected to one another via the at least one signal line and/or bus line. Likewise, it is however also possible to design the first axle unit 10 without its “own” first control device 28 and/or the second axle unit without its “own” second control device. Where applicable, the electrically controllable components of the first axle unit are controlled by the second control device of the second axle unit or the electrically controllable components of the second axle unit are controlled by the first control device 28 via the at least one signal line and/or bus line. Alternatively, the electrically controllable components of the first axle unit and the electrically controllable components of the second axle unit can however also be controlled by an external (central) controller.

Preferably, the second axle unit of the brake systems explained above is a dual-circuit second axle unit which has a third brake circuit and a fourth brake circuit. The third brake circuit can be formed with a third motorized brake pressure buildup device, a third wheel brake cylinder assigned to the first wheel of the second axle, and a third outlet valve. Likewise, the fourth brake circuit can comprise a fourth motorized brake pressure buildup device, a fourth wheel brake cylinder assigned to the other wheel of the second axle, and a fourth outlet valve. In this case, the third brake circuit and the fourth brake circuit are preferably each designed in such a way that, by means of operation of the motorized brake pressure buildup device thereof, brake fluid can be transferred from the or another connected brake fluid reservoir into the wheel brake cylinder thereof and, via the outlet valve thereof, brake fluid can be discharged from the wheel brake cylinder thereof into the connected brake fluid reservoir. In particular, all “axle units” shown by means of FIGS. 1 to 10 can also be used as a second axle unit. The “axle units” of FIGS. 1 to 10 can also be combined with one another as desired. The at least one third axle unit that may be present in the brake system can also have the features of the second axle unit described here in this paragraph.

Alternatively, however, the second axle unit can also have a relevant electromechanical wheel brake for each wheel of the second axle. The second axle unit can thus optionally be designed as a “hydraulic” axle unit or as an “electric” axle unit. The second axle unit can thus also be designed to be relatively cost-effective. Accordingly, the at least one third axle unit that may present in the brake system can also have the features of the second axle unit described in this paragraph.

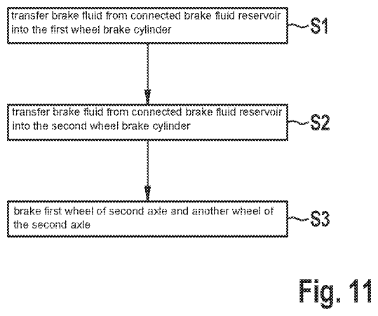

FIG. 11 shows a flowchart for explaining an embodiment of the method for braking a vehicle having at least two axles.

The method described below can, for example, be performed by means of one of the brake systems explained above. However, feasibility of the method is not limited to the use of one of these brake systems. Feasibility of the method is also not restricted to a special vehicle type/motor vehicle type of the two-axle vehicle/motor vehicle.

When the method is performed, a first wheel of a first axle of the vehicle and another wheel of the first axle are braked by increasing, by means of operation of at least one motorized brake pressure buildup device of a first axle unit installed on the first axle, a first brake pressure in a first wheel brake cylinder assigned to the first wheel of the first axle and a second brake pressure in a second wheel brake cylinder assigned to the other wheel of the first axle. In a method step S1, by means of operation of a first motorized brake pressure buildup device of a first brake circuit of the first axle unit, brake fluid is transferred from a connected brake fluid reservoir into the first wheel brake cylinder of the first brake circuit in order to increase the first brake pressure, while brake fluid is discharged from the first wheel brake cylinder into the connected brake fluid reservoir via a first outlet valve of the first brake circuit in order to reduce the first brake pressure. Correspondingly, in a method step S2, by means of operation of a second motorized brake pressure buildup device of a second brake circuit of the first axle unit, brake fluid is transferred from the or another connected brake fluid reservoir into the second wheel brake cylinder of the second brake circuit in order to increase the second brake pressure, but brake fluid is discharged from the second wheel brake cylinder into the connected brake fluid reservoir via a second outlet valve of the second brake circuit in order to reduce the second brake pressure.

In addition, in a method step S3, a first wheel of a second axle of the vehicle and another wheel of the second axle are braked by means of operation of a second axle unit which is installed on the second axle and is designed to be hydraulically separate from the first axle unit. Method steps S1 to S3 can be performed in any order, simultaneously or overlapping in time.

The method described here also has the advantages already explained above. As an alternative or in order to enhance method step S2, the second brake pressure can (additionally) be increased by transferring, by means of operation of the first motorized brake pressure buildup device, brake fluid from the connected brake fluid reservoir into the second wheel brake cylinder via a brake circuit connection line with a disconnect valve arranged therein and controlled to be at least partially open, a first mouth of the brake circuit connection line at the first brake circuit between the first motorized brake pressure buildup device and the first wheel brake cylinder, and a second mouth of the brake circuit connection line at the second brake circuit between the second motorized brake pressure buildup device and the second wheel brake cylinder. Correspondingly, the first brake pressure can also be (additionally) increased as an alternative or in order to enhance method step S1.

1-10. (canceled)

11. A brake system for a vehicle having at least two axles, the brake system comprising:
a first axle unit which can be installed or is installed on a first axle of the vehicle, the first axle using including at least one motorized brake pressure buildup device, a first wheel brake cylinder, and a second wheel brake cylinder, wherein, by operation of the at least one motorized brake pressure buildup device, a first brake pressure in the first wheel brake cylinder and a second brake pressure in the second wheel brake cylinder can be increased so that a first wheel of the first axle assigned to the first wheel brake cylinder and another wheel of the first axle assigned to the second wheel brake cylinder can be braked; and
a second axle unit which can be installed or is installed on a second axle of the vehicle and is hydraulically separate from the first axle unit, so that, by operation of the second axle unit, a first wheel of the second axle and another wheel of the second axle can be braked;
wherein the first axle unit is a dual-circuit first axle unit which includes a first brake circuit having a first motorized brake pressure buildup device, the first wheel brake cylinder, and a first outlet valve, and a second brake circuit having a second motorized brake pressure buildup device, the second wheel brake cylinder, and a second outlet valve, wherein the first brake circuit and the second brake circuit are each configured in such a way that, by operation of the first and second motorized brake pressure buildup device, respectively, brake fluid can be transferred from a connected brake fluid reservoir into the first and second wheel brake cylinder, respectively, and, via the first and second outlet valve, respectively, brake fluid can be discharged from the first and second wheel brake cylinder, respectively, into the connected brake fluid reservoir.

12. The brake system according to claim 11, wherein the first axle unit is hydraulically separate from the second axle unit in such a way that the first axle unit and the second axle unit are at most connected to one another via at least one signal line and/or bus line.

13. The brake system according to claim 11, wherein the first brake circuit and the second brake circuit of the first axle unit are connected to one another via a brake circuit connection line with a disconnect valve arranged therein, wherein a first mouth of the brake circuit connection line is located at the first brake circuit between the first motorized brake pressure buildup device and the first wheel brake cylinder, and a second mouth of the brake circuit connection line is located at the second brake circuit between the second motorized brake pressure buildup device and the second wheel brake cylinder.

14. The brake system according to claim 13, wherein: (i) the first brake circuit has a first check valve which is arranged between the first mouth of the brake circuit connection line and the first motorized brake pressure buildup device and is oriented in such a way that brake fluid transfer in a direction from the first mouth to the first motorized brake pressure buildup device is prevented by the first check valve, and/or (ii) the second brake circuit has a second check valve which is arranged between the second mouth of the brake circuit connection line and the second motorized brake pressure buildup device and is oriented in such a way that brake fluid transfer in a direction from the second mouth to the second motorized brake pressure buildup device is prevented by the second check valve.

15. The brake system according to claim 13, wherein: (i) the first brake circuit has a first isolating valve arranged between the first motorized brake pressure buildup device and the first wheel brake cylinder, and/or (ii) the second brake circuit has a second isolating valve arranged between the second motorized brake pressure buildup device and the second wheel brake cylinder.

16. The brake system according to claim 15, wherein: (i) the first brake circuit has a third check valve which is arranged parallel to the first isolating valve and is oriented in such a way that brake fluid transfer in a direction from the first wheel brake cylinder to the first motorized brake pressure buildup device is prevented by the third check valve, and/or (ii) the second brake circuit has a fourth check valve which is arranged parallel to the second isolating valve and is oriented in such a way that brake fluid transfer in a direction from the second wheel brake cylinder to the second motorized brake pressure buildup device is prevented by the fourth check valve.

17. The brake system according to claim 13, wherein the first axle unit further includes a master brake cylinder to which a brake actuating element of the vehicle can be connected or is connected in such a way that at least one piston of the master brake cylinder delimiting at least one chamber of the master brake cylinder can be displaced by actuation of the brake actuating element by a driver of the vehicle, and wherein the at least one chamber of the master brake cylinder is hydraulically connected to the brake circuit connection line, and/or to the first brake circuit and/or to the second brake circuit, via at least one valveless or valve-equipped connection line.

18. The brake system according to claim 11, wherein the second axle unit is a dual-circuit second axle unit which including a third brake circuit having a third motorized brake pressure buildup device, a third wheel brake cylinder assigned to the first wheel of the second axle, and a third outlet valve, and a fourth brake circuit having a fourth motorized brake pressure buildup device, a fourth wheel brake cylinder assigned to another wheel of the second axle, and a fourth outlet valve, wherein the third brake circuit and the fourth brake circuit are each configured in such a way that, by operation of the third and fourth motorized brake pressure buildup device, respectively, brake fluid can be transferred from a connected brake fluid reservoir into the third and fourth wheel brake cylinder, respectively, and, via the third and fourth outlet valve, respectively, brake fluid can be discharged from the third and fourth wheel brake cylinder, respectively, into the connected brake fluid reservoir.

19. A method for braking a vehicle having at least two axles, the method comprising the steps of:
braking a first wheel of a first axle of the vehicle and another wheel of the first axle by increasing, by operation of at least one motorized brake pressure buildup device of a first axle unit installed on the first axle, a first brake pressure in a first wheel brake cylinder assigned to the first wheel of the first axle and a second brake pressure in a second wheel brake cylinder assigned to another wheel of the first axle; and
braking a first wheel of a second axle of the vehicle and another wheel of the second axle by operation of a second axle unit which is installed on the second axle and is hydraulically separate from the first axle unit;
wherein, by operation of a first motorized brake pressure buildup device of a first brake circuit of the first axle unit, brake fluid is transferred from a connected brake fluid reservoir into the first wheel brake cylinder of the first brake circuit to increase the first brake pressure, and brake fluid is discharged from the first wheel brake cylinder into the connected brake fluid reservoir via a first outlet valve of the first brake circuit to reduce the first brake pressure; and
by operation of a second motorized brake pressure buildup device of a second brake circuit of the first axle unit, brake fluid is transferred from a connected brake fluid reservoir into the second wheel brake cylinder of the second brake circuit to increase the second brake pressure, and brake fluid is discharged from the second wheel brake cylinder into the connected brake fluid reservoir via a second outlet valve of the second brake circuit to reduce the second brake pressure.

20. The method according to claim 19, wherein the second brake pressure is increased by transferring, by operation of the first motorized brake pressure buildup device, brake fluid from the connected brake fluid reservoir into the second wheel brake cylinder via a brake circuit connection line with a disconnect valve arranged therein and controlled to be at least partially open, a first mouth of the brake circuit connection line at the first brake circuit being between the first motorized brake pressure buildup device and the first wheel brake cylinder, and a second mouth of the brake circuit connection line at the second brake circuit being between the second motorized brake pressure buildup device and the second wheel brake cylinder.
